(19) United States
(12) Patent Application Publication
(10) Pub. No.: US 2026/0170632 A1
(43) Pub. Date: Jun. 18, 2026

(54) METHOD AND APPARATUS FOR DETECTING DARK SPOTS ON END FACE OF OPTICAL FIBER IMAGE TRANSMISSION ELEMENT

(71) Applicants: CHINA BUILDING MATERIALS ACADEMY CO., LTD., Beijing (CN); China National Building Material Group Co., Ltd., Beijing (CN)

(72) Inventors: Ran Zhao, Beijing (CN); Bo Liu, Beijing (CN); Yuwen Xing, Beijing (CN); Peng Jiao, Beijing (CN); Yajie Du, Beijing (CN); Danqi Zhao, Beijing (CN); Yan Duan, Beijing (CN); Rui Zhang, Beijing (CN)

(73) Assignees: CHINA BUILDING MATERIALS ACADEMY CO., LTD., Beijing (CN); China National Building Material Group Co., Ltd., Beijing (CN)

(21) Appl. No.: 19/306,492

(22) Filed: Aug. 21, 2025

(30) Foreign Application Priority Data
Dec. 16, 2024 (CN) 2024118518004

(51) Int. Cl. G06T 7/00; G01M 11/00; G06T 5/20; G06T 5/70; G06T 7/62

(52) U.S. Cl. CPC G06T 7/0006; G01M 11/30; G06T 5/20; G06T 5/70; G06T 7/62; G06T 2207/20021; G06T 2207/20056; G06T 2207/30108; G06T 2207/30242

(57) ABSTRACT

A method for detecting dark spots on an end face of an optical fiber image transmission element comprises: obtaining a plurality of end face images for an optical fiber image transmission element to be detected by capturing different regions of the end face of the optical fiber image transmission element to be detected using a shooting apparatus; performing secondary windowed Fourier transform processing on each of the end face images based on a plurality of preset windows to generate a secondary masked image for each of the end face images, where the secondary masked image includes a plurality of closed regions; and determining the number of dark spots included in each of the end face images and an area value for each dark spot according to the number of closed regions included in each of the secondary masked images and the number of pixel points included in each closed region.

### TECHNICAL FIELD

The present application relates to the technical field of detection of an optical fiber image transmission element, in particular to a method and apparatus for detecting dark spots on an end face of an optical fiber image transmission element.

### BACKGROUND

Optical fiber image transmission elements (such as fiber optical plates, fiber optical inverters, and fiber optical tapers) are rod bundles of optical fiber materials composed of tens of thousands to hundreds of thousands of micron-sized optical fibers. Based on the principle of total internal reflection at an interface, images can be transmitted from one end of the optical fiber image transmission element to the other end. Optical fiber image transmission elements are widely used in optoelectronic devices such as image intensifiers, image-intensified CCDs, and particle detectors. Dark spots are a type of end-face optical defect caused by physical and chemical effects during the production and processing of optical fiber image transmission elements. Visually, dark spots mainly appear as shadow spots on the end face of the optical fiber image transmission element. The area of a dark spot is usually 20-250 square microns, which is equivalent to the area of 1-10 mono fibers. The number of dark spots included in the end face of the optical fiber image transmission element and the area of each dark spot are important indicators for evaluating the production quality of optical fiber image transmission elements.

Currently, inspectors generally observe the end face of the optical fiber image transmission element under a microscope and detect the number of dark spots included in the end face of the optical fiber image transmission element and the area of each dark spot through manual identification. However, dark spot detection on optical fiber image transmission elements by inspectors through manual identification completely depends on the work experience and working state of the inspectors. When the inspectors lack work experience or are in a poor working state, they cannot accurately detect the number of dark spots included in the end face of the optical fiber image transmission element and the area of each dark spot. Therefore, the detection accuracy of dark spot detection on optical fiber image transmission elements by the inspectors through manual identification is relatively low.

### SUMMARY OF THE INVENTION

Embodiments of the present application provide a method and apparatus for detecting dark spots on an end face of an optical fiber image transmission element, mainly aiming to improve the detection accuracy of dark spot detection for the optical fiber image transmission elements.

To solve the above technical problem, embodiments of the present application provide the following technical solutions:

In a first aspect, the present application provides a method for detecting dark spots on an end face of an optical fiber image transmission element, and the method includes:
obtaining a plurality of end face images corresponding to an optical fiber image transmission element to be detected, wherein the plurality of end face images are obtained by capturing different regions of the end face of the optical fiber image transmission element to be detected using a shooting apparatus;
performing secondary windowed Fourier transform processing on each of the end face images based on a plurality of preset windows to generate a secondary masked image corresponding to each of the end face images, wherein the secondary masked image includes a plurality of closed regions; and
determining the number of dark spots included in each of the end face images and an area value corresponding to each dark spot according to the number of closed regions included in each of the secondary masked images and the number of pixel points included in each closed region.

In a second aspect, the present application further provides an apparatus for detecting dark spots on an end face of an optical fiber image transmission element, and the apparatus includes:
an acquisition unit, configured to obtain a plurality of end face images corresponding to an optical fiber image transmission element to be detected, wherein the plurality of end face images are images obtained by capturing different regions of the end face of an optical fiber image transmission element to be detected through a shooting apparatus;
a first processing unit, configured to perform secondary windowed Fourier transform processing on each of the end face images based on a plurality of preset windows to generate a secondary masked image corresponding to each of the end face images, wherein the secondary masked image includes a plurality of closed regions; and
a first determining unit, configured to determine the number of dark spots included in each of the end face images and an area value corresponding to each dark spot according to the number of closed regions included in each of the secondary masked images and the number of pixel points included in each closed region.

In a third aspect, embodiments of the present application provide a storage medium, wherein the storage medium includes a stored program, when the program runs, it controls a device where the storage medium is located to execute the method for detecting dark spots on an end face of an optical fiber image transmission element as claimed in the first aspect.

In a fourth aspect, embodiments of the present application provide an apparatus for detecting dark spots on an end face of an optical fiber image transmission element, and the apparatus includes a storage medium and one or more processors, wherein the storage medium is coupled to the processor, and the processor is configured to execute program instructions stored in the storage medium; and the program instructions, when running, execute the method for detecting dark spots on an end face of an optical fiber image transmission element as claimed in the first aspect.

With the above technical solutions, the technical solutions provided by the present application have at least the following advantages:

The present application provides a method and apparatus for detecting dark spots on the end face of an optical fiber image transmission element. In the present application, after inspectors capture a plurality of end face images corresponding to the optical fiber image transmission element to be detected by using a shooting apparatus and store the plurality of end face images corresponding to the optical fiber image transmission element to be detected in a local storage space of a target terminal device, a dark spot detection application obtains a plurality of end face images corresponding to the optical fiber image transmission element to be detected from the local storage space of the target terminal device, then performs secondary windowed Fourier transform processing on each end face image based on a plurality of preset windows, to generate a secondary masked image corresponding to each end face image. For any end face image, its corresponding secondary masked image includes a plurality of closed regions. For any closed region, it corresponds to a dark spot or a dust particle. Moreover, the dark spot detection application determines the number of dark spots included in each of the end face images and the area value corresponding to each dark spot according to the number of closed regions included in each secondary masked image and the number of pixel points included in each closed region. In the present application, the inspectors only need to capture a plurality of end face images corresponding to the optical fiber image transmission element to be detected by using the shooting apparatus, then the dark spot detection application can determine the number of dark spots included in each of the end face images and the area value corresponding to each dark spot, and also determine the number of dark spots included in the end face of the optical fiber image transmission element to be detected and the area size of each dark spot. No intervention from the inspectors is required throughout the whole process, thereby eliminating dependence on the work experience and working state of the inspectors, and improving the detection accuracy of dark spot detection for optical fiber image transmission elements.

The above description is merely an overview of the technical solution of the present application. In order to more clearly understand the technical means of the present application and implement in accordance with the content of the specification, and to make the above and other objects, features and advantages of the present application more obvious and understandable, specific embodiments of the present application are specifically presented below.

### BRIEF DESCRIPTION OF THE DRAWINGS

By reading the following detailed description with reference to the accompanying drawings, the above and other objects, features, and advantages of the exemplary embodiments of the present application will become easily understandable. In the accompanying drawings, several embodiments of the present application are shown by way of example and not limitation, and identical or corresponding reference numerals denote identical or corresponding parts, wherein

FIG. 1 shows a flowchart of a method for detecting dark spots on the end face of an optical fiber image transmission element provided by an embodiment of the present application;

FIG. 2 shows a flowchart of another method for detecting dark spots on the end face of an optical fiber image transmission element provided by an embodiment of the present application;

FIG. 3 shows a block diagram of the composition of an apparatus for detecting dark spots on the end face of an optical fiber image transmission element provided by an embodiment of the present application;

FIG. 4 shows a block diagram of the composition of another apparatus for detecting dark spots on the end face of an optical fiber image transmission element provided by an embodiment of the present application.

### DETAILED DESCRIPTION OF EMBODIMENTS

Hereinafter, exemplary embodiments of the present application will be described in more detail with reference to the accompanying drawings. Although the exemplary embodiments of the present application are shown in the drawings, it should be understood that the present application can be implemented in various forms and should not be limited by the embodiments set forth herein. On the contrary, these embodiments are provided such that the present application can be more thoroughly understood and the scope of the present application can be fully conveyed to those skilled in the art.

In addition, words such as “first”, “second” and similar terms used in the present application do not denote any order, quantity or importance, but are merely used to distinguish different parts.

It should be noted that, unless otherwise specified, the technical or scientific terms used in the present application shall have ordinary meanings understood by those skilled in the field to which the present application belongs.

Currently, inspectors generally observe the end face of the optical fiber image transmission element under a microscope and detect the number of dark spots included in the end face of the optical fiber image transmission element and the area of each dark spot through manual identification. However, dark spot detection on optical fiber image transmission elements by inspectors through manual identification completely depends on the work experience and working state of the inspectors. When the inspectors lack work experience or are in a poor working state, they cannot accurately detect the number of dark spots included in the end face of the optical fiber image transmission element and the area of each dark spot. Therefore, the detection accuracy of dark spot detection on optical fiber image transmission elements by the inspectors through manual identification is relatively low.

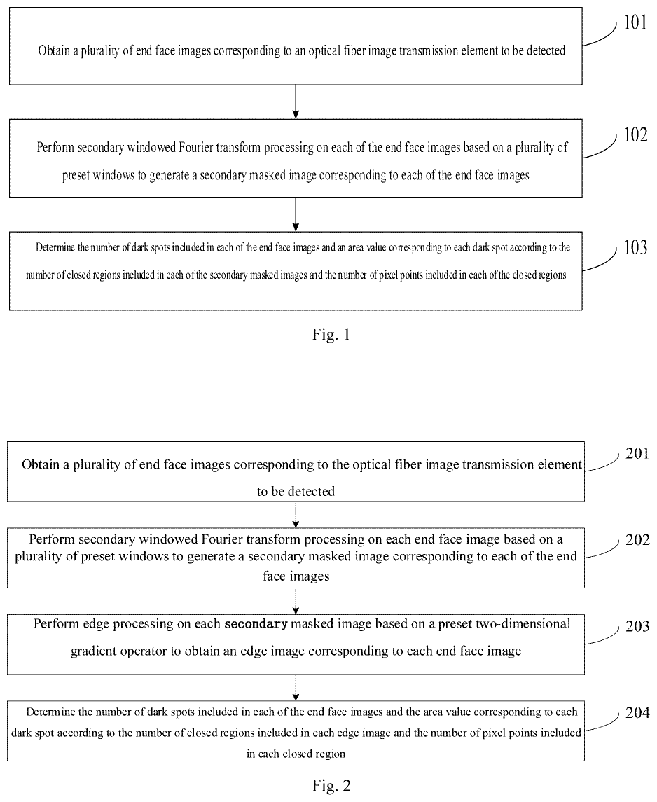

Therefore, in order to improve the detection accuracy of dark spot detection for optical fiber image transmission elements, the embodiments of the present application provide a method for detecting dark spots on the end face of an optical fiber image transmission element. As shown in FIG. 1, the method includes at least steps 101 to 103.

101: obtaining a plurality of end face images corresponding to an optical fiber image transmission element to be detected.

The inspectors can divide the end face of the optical fiber image transmission element to be detected into a plurality of regions, and separately capture the end face image corresponding to each region by using a shooting apparatus, so as to obtain a plurality of end face images corresponding to the optical fiber image transmission element to be detected. At this time, the plurality of end face images captured completely cover the end face of the optical fiber image transmission element to be detected; the inspectors can also take a center point of the end face of the optical fiber image transmission element to be detected as an origin, select a plurality of regions on the end face of the optical fiber image transmission element to be detected, and separately capture the end face image corresponding to each region by using the shooting apparatus, so as to obtain a plurality of end face images corresponding to the optical fiber image transmission element to be detected. At this time, the plurality of end face images captured partially cover the end face of the optical fiber image transmission element to be detected, but it is not limited hereto.

In the embodiments of the present application, an execution subject of each step is a dark spot detection application running in the target terminal device. Herein, the target terminal device can be, but is not limited to, a computer, a tablet computer, a laptop computer, etc.

The shooting apparatus is electrically connected to the target terminal device. After the shooting apparatus captures a plurality of end face images corresponding to the optical fiber image transmission element to be detected, it can send the plurality of end face images corresponding to the optical fiber image transmission element to be detected to the target terminal device, then the target terminal device can store the plurality of end face images corresponding to the optical fiber image transmission element to be detected in a local storage space. When dark spot detection needs to be performed on the optical fiber image transmission element to be detected, the dark spot detection application can obtain the plurality of end face images corresponding to the optical fiber image transmission element to be detected from the local storage space of the target terminal device.

It should be noted that the shooting apparatus includes an industrial camera and a microscope. The magnification of the microscope can be, but is not limited to, 20 times, 30 times, 40 times, 50 times, etc. The chip size and pixel pitch of the industrial camera are determined according to the diameter of an mono fiber corresponding to the optical fiber image transmission element to be detected, the magnification of the microscope, and preset rules. For example, the preset rules are as follows: (1) the diameter of each mono fiber included in the optical fiber image transmission element to be detected occupies at least 25 pixel points in the end face image; (2) the larger the field of view of the shooting apparatus, the better; (3) the budget cost of the shooting apparatus is A, the magnification of the microscope is 20 times, and the diameter of the mono fiber corresponding to the optical fiber image transmission element to be detected is 5 microns, therefore, the pitch (side length) of each pixel point in the end face image should be less than 0.2 micron (5 microns divided by 25), while the pitch (side length) of each pixel point in the end face image is equal to the pixel pitch of the industrial camera divided by the magnification. Therefore, the pixel pitch of the industrial camera needs to be less than 4 microns, while the field of view of the shooting apparatus is equal to the chip size of the industrial camera divided by the magnification of the microscope. Since the magnification of the microscope remains unchanged, the larger the chip size of the industrial camera, the larger the field of view of the shooting apparatus. However, the larger the chip size of the industrial camera, the higher the cost. Therefore, it is necessary to select a camera chip with a larger size under the condition that the budget cost of the shooting apparatus is less than or equal to A.

102: performing secondary windowed Fourier transform processing on each of the end face images based on a plurality of preset windows to generate a secondary masked image corresponding to each of the end face images.

For any mono fiber included in the optical fiber image transmission element to be detected, the mono fiber includes core glass and cladding glass, wherein the core glass is cylindrical, and the cladding glass wraps around the outer surface of the core glass; the end face of the core glass is circular, and the end face of the cladding glass is annular.

The dark spots on the surface of the optical fiber image transmission element are composed of one or more mono fibers that cannot emit light normally. In the end face image, fringe frequency values of the pixel points corresponding to the dark spots (and dust particles) are lower than the fringe frequency values of the pixel points corresponding to the normally-emitting mono fibers.

After obtaining a plurality of end face images corresponding to the optical fiber image transmission element to be detected, the dark spot detection application needs to perform secondary windowed Fourier transform processing on each of the end face images based on a plurality of preset windows, that is, the dark spot detection application selects an appropriate window from the plurality of preset windows, performs two rounds of windowed Fourier transform processing on each end face image based on the selected window, and then sets the gray value of the pixel points corresponding to the normally-emitting mono fibers in each end face image to 0 based on the characteristic that the fringe frequency value of the pixel points corresponding to the dark spots (and dust particles) is lower than the fringe frequency value of the pixel points corresponding to the normally-emitting mono fibers, so as to mask the pixel points corresponding to the normally-emitting mono fibers and generate the secondary masked image corresponding to each end face image.

For any end face image, the corresponding secondary masked image includes a plurality of closed regions. For any closed region, it corresponds to a dark spot or a dust particle. For any end face image, in its corresponding secondary masked image, the gray value of the pixel points corresponding to the normally-emitting mono fibers is 0, and the gray value of the pixel points corresponding to the dark spots (and dust particles) is not 0.

103: determining the number of dark spots included in each of the end face images and the area value corresponding to each dark spot according to the number of closed regions included in each of the secondary masked images and the number of pixel points included in each closed region.

After generating the secondary masked image corresponding to each end face image, the dark spot detection application can determine the number of dark spots included in each of the end face images and the area value corresponding to each dark spot according to the number of closed regions included in each secondary masked image and the number of pixel points included in each closed region. Moreover, the dark spot detection application can determine the number of dark spots included in the end face of the optical fiber image transmission element to be detected and the area size of each dark spot according to the number of dark spots included in each of the end face images and the area value corresponding to each dark spot. That is, when a plurality of end face images completely cover the end face of the optical fiber image transmission element to be detected, the sum of the number of dark spots included in the plurality of end face images is the number of dark spots included in the end face of the optical fiber image transmission element to be detected, and the area value corresponding to each dark spot included in the plurality of end face images is the area size of each dark spot included in the end face of the optical fiber image transmission element to be detected.

Specifically, in this step, for any end face image, the specific process of determining the number of dark spots included in the end face image and the area value corresponding to each dark spot according to the number of closed regions included in the secondary masked image corresponding to the end face image and the number of pixel points included in each closed region is as follows:
firstly, calculating the number of occupied pixel points corresponding to the diameter of an mono fiber according to the diameter of the mono fiber corresponding to the optical fiber image transmission element to be detected and the pitch of a pixel point corresponding to the end face image, that is, the diameter of an mono fiber corresponding to the optical fiber image transmission element to be detected is divided by the pitch of the pixel point corresponding to the end face image (the side length of the pixel point), and the calculation result is determined as the number of occupied pixel points corresponding to the diameter of the mono fiber, wherein the number of occupied pixel points corresponding to the diameter of an mono fiber refers to the number of occupied pixel points corresponding to the diameter of the mono fiber in the end face image. Secondly, calculating the number of occupied pixel points corresponding to the mono fiber according to the number of occupied pixel points corresponding to the diameter of the mono fiber, wherein the number of occupied pixel points corresponding to the mono fiber refers to the number of pixel points occupied by the end face of an mono fiber in the end face image. Thirdly, for any closed region included in the secondary masked image, when the number of pixel points included in the closed region is less than the number of occupied pixel points corresponding to the mono fiber, determining that the closed region corresponds to a dust particle; when the number of pixel points included in the closed region is greater than or equal to the number of occupied pixel points corresponding to the mono fiber, determining that the closed region corresponds to a dark spot. Finally, counting the number of closed regions corresponding to dust particles, the number of closed regions corresponding to dark spots, and the number of pixel points included in each closed region corresponding to a dark spot among the plurality of closed regions included in the secondary masked image. If the number of closed regions corresponding to dust particles is greater than a preset threshold, a prompt message is output and displayed to remind the inspectors that there is too much dust on the end face of the optical fiber image transmission element to be detected, and the inspectors need to wipe the optical fiber image transmission element to be detected and then re-capture a plurality of end face images corresponding to the optical fiber image transmission element to be detected. If the number of closed regions corresponding to dust particles is less than or equal to the preset threshold, the area value corresponding to each closed region is calculated according to the number of pixel points included in each closed region corresponding to the dark spot and the area value of a pixel point corresponding to the end face image (which is calculated according to the side length of a pixel point), the number of closed regions corresponding to dark spots is determined as the number of dark spots included in the end face image, and the area value corresponding to each closed region corresponding to a dark spot is determined as the area value corresponding to each dark spot included in the end face image.

The embodiments of the present application provide a method for detecting dark spots on the end face of an optical fiber image transmission element. In the embodiments of the present application, after inspectors capture a plurality of end face images corresponding to the optical fiber image transmission element to be detected by using a shooting apparatus and store the plurality of end face images corresponding to the optical fiber image transmission element to be detected in a local storage space of a target terminal device, a dark spot detection application obtains a plurality of end face images corresponding to the optical fiber image transmission element to be detected from the local storage space of the target terminal device, then performs secondary windowed Fourier transform processing on each end face image based on a plurality of preset windows, to generate a secondary masked image corresponding to each end face image. For any end face image, its corresponding secondary masked image includes a plurality of closed regions. For any closed region, it corresponds to a dark spot or a dust particle. Moreover, the dark spot detection application determines the number of dark spots included in each of the end face images and the area value corresponding to each dark spot according to the number of closed regions included in each secondary masked image and the number of pixel points included in each closed region. In the embodiments of the present application, the inspectors only need to capture a plurality of end face images corresponding to the optical fiber image transmission element to be detected by using the shooting apparatus, then the dark spot detection application can determine the number of dark spots included in each of the end face images and the area value corresponding to each dark spot, and also determine the number of dark spots included in the end face of the optical fiber image transmission element to be detected and the area size of each dark spot. No intervention from the inspectors is required throughout the whole process, thereby eliminating dependence on the work experience and working state of the inspectors, and improving the detection accuracy of dark spot detection for optical fiber image transmission elements.

In order to provide a more detailed description, the embodiments of the present application provide another method for detecting dark spots on the end face of an optical fiber image transmission element, as specifically shown in FIG. 2, this method includes at least steps 201 to 204.

201: obtaining a plurality of end face images corresponding to the optical fiber image transmission element to be detected.

Regarding obtaining a plurality of end face images corresponding to the optical fiber image transmission element to be detected in step 201, reference can be made to the description of the corresponding part in FIG. 1, and the embodiments of the present application will not repeat it herein.

202: performing secondary windowed Fourier transform processing on each end face image based on a plurality of preset windows to generate a secondary masked image corresponding to each of the end face images.

After obtaining a plurality of end face images corresponding to the optical fiber image transmission element to be detected, the dark spot detection application needs to perform secondary windowed Fourier transform processing on each of the end face images based on a plurality of preset windows, that is, the dark spot detection application selects an appropriate window from the plurality of preset windows, performs two rounds of windowed Fourier transform processing on each end face image based on the selected window, and then sets the gray value of the pixel points corresponding to the normally-emitting mono fibers in each end face image to 0 based on the characteristic that the fringe frequency value of the pixel points corresponding to the dark spots (and dust particles) is lower than the fringe frequency value of the pixel points corresponding to the normally-emitting mono fibers, so as to mask the pixel points corresponding to the normally-emitting mono fibers and generate the secondary masked image corresponding to each end face image. The following will describe in detail how the dark spot detection application performs secondary windowed Fourier transform processing on each end face image based on a plurality of preset windows to generate a secondary masked image corresponding to each end face image:

The plurality of preset windows include a plurality of first preset windows and a plurality of second preset windows, wherein the first preset windows are Gaussian windows, and the second preset windows are inclined windows.

(1) Calculating the number of occupied pixel points corresponding to the diameter of an mono fiber according to the diameter of the mono fiber corresponding to the optical fiber image transmission element to be detected and the pitch of a pixel point corresponding to the end face image, that is, the diameter of an mono fiber corresponding to the optical fiber image transmission element to be detected is divided by the pitch of the pixel point corresponding to the end face image (the side length of the pixel point), and the calculation result is determined as the number of occupied pixel points corresponding to the diameter of the mono fiber, wherein the number of occupied pixel points corresponding to the diameter of an mono fiber refers to the number of occupied pixel points corresponding to the diameter of an mono fiber in the end face image.

(2) Generating a target noise reduction matrix according to the number of occupied pixel points corresponding to the diameter of an mono fiber, and selecting a target Gaussian window from the plurality of first preset windows according to the number of occupied pixel points corresponding to the diameter of an mono fiber.

When the number of occupied pixel points corresponding to the diameter of an mono fiber is an odd number, the generated target noise reduction matrix is specifically as follows:

$$nk \qquad nk \qquad nk \qquad … \qquad nk \qquad nk \qquad nk$$

$$nk \qquad ⋮ \qquad nk$$

$$nk \qquad n 3 \qquad n 3 \qquad n 3 \qquad nk$$

$$⋮ \qquad … \qquad n 3 \qquad n 1 \qquad n 3 \qquad … \qquad ⋮$$

$$nk \qquad n 3 \qquad n 3 \qquad n 3 \qquad nk$$

$$nk \qquad ⋮ \qquad nk$$

$$nk \qquad nk \qquad nk \qquad … \qquad nk \qquad nk \qquad nk$$

Wherein the target noise reduction matrix is a k*k matrix. The target noise reduction matrix takes n1 as a center, with a circle of elements surrounding n1 all being n3, a circle of elements surrounding a plurality of n3 being n5 . . . , and the outermost circle of elements being nk, and k is the number of occupied pixel points corresponding to the diameter of an mono fiber, wherein the sum of a plurality of elements included in the target noise reduction matrix is equal to 1.

Where n1=2/(k+1),ni=1/[2(k+1)(i−1)], i=3,5,7 . . . k.

When the number of occupied pixel points corresponding to the diameter of an mono fiber is an even number, the generated target noise reduction matrix is specifically as follows:

$$nk \qquad nk \qquad nk \qquad … \qquad nk \qquad nk \qquad nk$$

$$nk \qquad ⋮ \qquad nk$$

$$nk \qquad n 4 \qquad n 4 \qquad n 4 \qquad n 4 \qquad nk$$

$$⋮ \qquad … \qquad n 4 \qquad n 2 \qquad n 2 \qquad n 4 \qquad … \qquad ⋮$$

$$⋮ \qquad n 4 \qquad n 2 \qquad n 2 \qquad n 4 \qquad ⋮$$

$$nk \qquad n 4 \qquad n 4 \qquad n 4 \qquad n 4 \qquad nk$$

$$nk \qquad ⋮ \qquad nk$$

$$nk \qquad nk \qquad nk \qquad … \qquad nk \qquad nk \qquad nk$$

Wherein, the target noise reduction matrix is a k*k matrix. The target noise reduction matrix takes a 2*2 matrix as a center, with each element in the 2*2 matrix being n2, a circle of elements surrounding the 2*2 matrix all being n4, a circle of elements surrounding the plurality of n4 elements being n6 . . . , and the outermost circle of elements being nk, and k is the number of occupied pixel points corresponding to the diameter of an mono fiber, wherein the sum of a plurality of elements included in the target noise reduction matrix is equal to 1.

Where ni=1/[2k(i−1)], i=2, 4, 6 . . . k.

The specific process of selecting the target Gaussian window from a plurality of first preset windows according to the number of occupied pixel points corresponding to the diameter of an mono fiber is as follows:

A plurality of first preset windows are all Gaussian windows. For any first preset window, the first preset window is an N*N matrix, and the sum of a plurality of elements included in the first preset window is 1.

Among the plurality of first preset windows, the first preset window whose rows and columns are both equal to the number of occupied pixel points corresponding to the diameter of the mono fiber is determined as the target Gaussian window, that is, when the number of occupied pixel points corresponding to the diameter of the mono fiber is k, the first preset window with both rows and columns being k is determined as the target Gaussian window.

(3) Performing convolution operation processing on each end face image by using the target noise reduction matrix to obtain a noise reduction image corresponding to each end face image.

The type of convolution operation can be specifically the same convolution operation, that is, for any end face image, the target noise reduction matrix is used to perform the same convolution operation processing on the end face image to obtain a noise reduction image corresponding to the end face image.

When the target noise reduction matrix is used to perform the convolution operation processing on the end face image, noise points in the end face image can be suppressed.

(4) Performing windowed Fourier transform processing on each noise reduction image based on the target Gaussian window to generate a primary masked image corresponding to each of the end face images.

For any end face image:
firstly, performing windowed Fourier transform processing on the noise reduction image corresponding to the end face image based on the target Gaussian window to obtain a fringe frequency field corresponding to the noise reduction image, wherein the fringe frequency field includes the fringe frequency value corresponding to each pixel point in the noise reduction image; the specific process of performing windowed Fourier transform processing on the noise reduction image based on the target Gaussian window to obtain the fringe frequency field corresponding to the noise reduction image is as follows: firstly, performing windowed Fourier transform processing on the noise reduction image based on the target Gaussian window to determine a horizontal fringe frequency value and a vertical fringe frequency value corresponding to each pixel point in the noise reduction image; then, calculating the fringe frequency value corresponding to each pixel point according to the horizontal fringe frequency value and the vertical fringe frequency value corresponding to each pixel point; and finally, generating a fringe frequency field corresponding to the noise reduction image according to the fringe frequency values corresponding to a plurality of pixel points;
secondly, determining a fringe frequency value with the highest occurrence frequency in the fringe frequency field as a reference fringe frequency value;
thirdly, determining the fringe frequency values in the fringe frequency field that are greater than or equal to the reference fringe frequency value as target fringe frequency values;
then, determining the pixel points corresponding to each target fringe frequency value as target pixel points; and
finally, setting the gray value corresponding to each target pixel point in the noise reduction image to 0 to generate a primary masked image corresponding to the end face image.

It should be noted that in the noise reduction image, the number of pixel points corresponding to the normally-emitting mono fibers is the largest. Therefore, the fringe frequency value with the highest occurrence frequency in the fringe frequency field (i.e., the reference fringe frequency value) must be the fringe frequency value corresponding to the pixel points corresponding to the normally-emitting mono fibers. Therefore, after determining the fringe frequency values in the fringe frequency field that are greater than or equal to the reference fringe frequency value as the target fringe frequency values, determining the pixel points corresponding to each target fringe frequency value as the target pixel points, and setting the gray value corresponding to each target pixel point to 0 in the noise reduction image, the gray values of a large number of pixel points corresponding to each normally-emitting mono fiber can be effectively set to 0 and such pixel points are masked. However, the fringe frequency values of some pixel points corresponding to the normally-emitting mono fibers are less than the reference fringe frequency value, so these pixel points cannot be masked. Therefore, a second round of windowed Fourier transform processing is required.

(5) Selecting a target inclined window corresponding to each of the primary masked images from a plurality of second preset windows according to the number of occupied pixel points corresponding to the diameter of an mono fiber and a plurality of primary masked images.

For any primary masked image:
firstly, selecting an unmasked pixel point of the mono fiber in the primary masked image, that is, determining any pixel point within the unmasked region corresponding to any normally-emitting mono fiber in the primary masked image as the unmasked pixel point of the mono fiber. For any normally-emitting mono fiber, its corresponding unmasked region is a region composed of the pixel points that cannot be masked among the pixel points corresponding to this normally-emitting mono fiber after the first windowed Fourier transform processing;
secondly, obtaining the horizontal fringe frequency value and the vertical fringe frequency value corresponding to the unmasked pixel points of the mono fiber, and calculating a direction angle corresponding to the primary masked image according to the horizontal fringe frequency value and the vertical fringe frequency value corresponding to the unmasked pixel points of the mono fiber, that is, the horizontal fringe frequency value and the vertical fringe frequency value corresponding to the unmasked pixel points of the mono fiber are substituted into a preset formula to calculate a direction angle corresponding to the primary masked image. The specific preset formula is as follows:

$$θ = arctan Fy / Fx$$

where θ is the direction angle corresponding to the primary masked image, Fy is the vertical fringe frequency value corresponding to the unmasked pixel points of the mono fiber, and Fx is the horizontal fringe frequency value corresponding to the unmasked pixel points of the mono fiber; and
finally, the specific process of selecting a target inclined window corresponding to the primary masked image from the plurality of second preset windows according to the number of occupied pixel points corresponding to the diameter of an mono fiber and the direction angle corresponding to the primary masked image is as follows:
a plurality of second preset windows are all inclined windows, a plurality of second preset windows are divided into N groups, and each group includes four second preset windows: second preset window A, second preset window B, second preset window C, and second preset window D. For any group, each group corresponds to the number of occupied pixel points corresponding to the diameter of an mono fiber.

Firstly, selecting a target group according to the number of occupied pixel points corresponding to the diameter of the mono fiber, and then selecting a target inclined window corresponding to the primary masked image from the target group based on the direction angle corresponding to the primary masked image.

For example, when the number of occupied pixel points corresponding to the diameter of the mono fiber is 30, the group corresponding to 30 pixel points, which is the number of pixel points occupied by the diameter of the mono fiber, is determined as the target group. The target group includes: the second preset window 30A, the second preset window 30B, the second preset window 30C, and the second preset window 30D, wherein the second preset window 30A is a 15*30 matrix, and the value of each element in the matrix is 1; the second preset window 30B is a 30*44 matrix, in the first row of the matrix, the values of the 1st to 29th elements are 0, the values of the 30th to 44th elements are 1; in the second row, the values of the 1st to 28th elements are 0, the values of the 29th to 43rd elements are 1, and the value of the 44th element is 0; in the third row, the values of the 1st to 27th elements are 0, the values of the 28th to 42nd elements are 1, and the values of the 43rd to 44th elements are 0 . . . ; and in the thirtieth row, the values of the 1st to 15th elements are 1, and the values of the 16th to 44th elements are 0; the second preset window 30C is a 30*15 matrix, and the values of the elements in the matrix are all 1; the second preset window 30D is a 30*44 matrix, in the first row of the matrix, the values of the 1st to 15th elements in the first row are 1, the values of the 16th to 44th elements are 0; in the second row, the value of the 1st element is 0, the values of the 2nd to 16th elements are 1, and the values of the 17th to 44th elements are 0; in the third row, the values of the 1st to 2nd elements are 0, the values of the 3rd to 17th elements are 1, and the values of the 18th to 44th elements are 0 . . . ; and in the thirtieth row, the values of the 1st to 29th elements are 0, and the values of the 30th to 44th elements are 1; when the direction angle θ corresponding to the primary masked image satisfies θ∈[0°,22.5°) or θ∈(157.5°,180°], the second preset window 30A is determined as the target inclined window corresponding to the primary masked image; when the direction angle θ corresponding to the primary masked image satisfies θ∈[22.5°,67.5°), the second preset window 30B is determined as the target inclined window corresponding to the primary masked image; when the direction angle θ corresponding to the primary masked image satisfies θ∈[67.5°,112.5°), the second preset window 30C is determined as the target inclined window corresponding to the primary masked image; and when the direction angle θ corresponding to the primary masked image satisfies θ∈[112.5°, 157.5°], the second preset window 30D is determined as the target inclined window corresponding to the primary masked image.

(6) Performing windowed Fourier transform processing on each of the primary masked images based on the target inclined window corresponding to each of the primary masked images to generate a secondary masked image corresponding to each of the end face images.

For any primary masked image:
firstly, performing windowed Fourier transform processing on the primary masked image based on the target inclined window corresponding to the primary masked image to obtain the fringe frequency field corresponding to the primary masked image, wherein the fringe frequency field includes the fringe frequency value corresponding to each pixel point in the primary masked image. For the specific process, reference can be made to the above description of performing windowed Fourier transform processing on the noise reduction image corresponding to the end face image based on the target Gaussian window to obtain the fringe frequency field corresponding to the noise reduction image. The embodiments of the present application will not repeat it herein;
secondly, determining a fringe frequency value with the highest occurrence frequency in the fringe frequency field as a reference fringe frequency value;
thirdly, determining the fringe frequency values in the fringe frequency field that are greater than or equal to the reference fringe frequency value as target fringe frequency values;
fourthly, determining the pixel points corresponding to each target fringe frequency value as target pixel points; and
finally, setting the gray value corresponding to each target pixel point in the primary masked image to 0 to generate a secondary masked image corresponding to the primary masked image.

203: Performing edge processing on each secondary masked image based on a preset two-dimensional gradient operator to obtain an edge image corresponding to each end face image.

After generating the secondary masked image corresponding to each end face image, the dark spot detection application can perform edge processing on each secondary masked image based on the preset two-dimensional gradient operator to obtain the edge image corresponding to each end face image. The specific process is as follows: firstly, performing binarization processing on each secondary masked image, that is, for any secondary masked image, the grayscale value of the pixel points whose grayscale value is not 0 in the secondary masked image is set to 1, so as to obtain a binary image corresponding to each end face image. Secondly, performing convolution operation processing on each binary image by using the preset two-dimensional gradient operator to obtain a gradient matrix corresponding to each binary image. Specifically, the type of convolution operation can be the same convolution operation. The preset two-dimensional gradient operator can be, but is not limited to, the Laplacian operator, the Sobel operator, etc. For any binary image, the plurality of pixel points in the binary image are in one-to-on correspondence with the plurality of elements in the gradient matrix corresponding to the binary image. The elements in the gradient matrix corresponding to the binary image indicate the gradient values of their corresponding pixel points. Secondly, performing edge processing on each binary image according to the gradient matrix corresponding to each binary image to obtain the edge image corresponding to each end face image, that is, for any binary image, the elements whose gradient values are not zero in the gradient matrix corresponding to the binary image are determined as the target elements, and the pixel points corresponding to each target element are determined as the target pixel points. In the binary image, the gray value of each target pixel point is set to 1, and the gray value of the other pixel points except the target pixel points is set to 0, so as to obtain the edge image. The target pixel points are the pixel points at the edge of the dark spot (or dust particle), that is, the gray value of the pixel point at the edge of each dark spot (or dust particle) in the edge image is 1, and the gray value of the other pixel points is 0. Therefore, the inspectors can quickly know the position of each dark spot (or dust particle) according to the edge image.

204: determining the number of dark spots included in each of the end face images and the area value corresponding to each dark spot according to the number of closed regions included in each edge image and the number of pixel points included in each closed region.

Regarding determining the number of dark spots included in each of the end face images and the area value corresponding to each dark spot according to the number of closed regions included in each edge image and the number of pixel points included in each closed region in step 204, reference can be made to the relevant description of the above step 103. The embodiments of the present application will not repeat it herein.

Further, in the embodiment of the present application, after determining the number of dark spots included in each of the end face images corresponding to the optical fiber image transmission element to be detected and the area value corresponding to each dark spot, whether the optical fiber image transmission element to be detected is a qualified element in dark spot detection can also be determined according to the number of dark spots included in each of the end face images and the area value corresponding to each dark spot. The specific process is as follows: firstly, determining the total area value corresponding to a plurality of first dark spots included in each of the end face images, and determining the number of second dark spots, the number of third dark spots, and the number of fourth dark spots included in each of the end face images, wherein the first dark spots are the dark spots in the end face image with an area value being less than or equal to the first preset area threshold; the second dark spots are the dark spots in the end face image with an area value being greater than the first preset area threshold and less than or equal to the second preset area threshold; the third dark spots are the dark spots in the end face image with an area value being greater than the second preset area threshold and less than or equal to the third preset area threshold; and the fourth dark spots are the dark spots in the end face image with an area value being greater than the third preset area threshold. When the total area value corresponding to a plurality of first dark spots included in any end face image is greater than the fourth preset area threshold, the optical fiber image transmission element to be detected is determined as an unqualified element in dark spot detection. When the number of second dark spots included in any end face image is greater than the first quantity threshold, the optical fiber image transmission element to be detected is determined as an unqualified element in dark spot detection. When the number of third dark spots included in any end face image is greater than the second quantity threshold, the optical fiber image transmission element to be detected is determined as an unqualified element in dark spot detection. When the number of fourth dark spots included in any end face image is greater than the third quantity threshold, the optical fiber image transmission element to be detected is determined as an unqualified element in dark spot detection.

The first preset area threshold can be, but is not limited to, a total end face area value corresponding to three mono fibers, a total end face area value corresponding to four mono fibers, a total end face area value corresponding to five mono fibers, etc. The second preset area threshold can be, but is not limited to, a total end face area value corresponding to eight mono fibers, a total end face area value corresponding to ten mono fibers, a total end face area value corresponding to twelve mono fibers, etc. The third preset area threshold can be, but is not limited to, a total end face area value corresponding to thirteen mono fibers, a total end face area value corresponding to fifteen mono fibers, a total end face area value corresponding to seventeen mono fibers, etc. The third preset area threshold is greater than the second preset area threshold, and the second preset area threshold is greater than the first preset area threshold. The fourth preset area threshold can be, but is not limited to, 2% of the end face image area, 3% of the end face image area, 4% of the end face image area, etc., wherein the first quantity threshold can be, but is not limited to, 3, 4, 5, etc. The second quantity threshold can be, but is not limited to, 1, 2, etc. The third quantity threshold can be, but is not limited to, 1, etc.

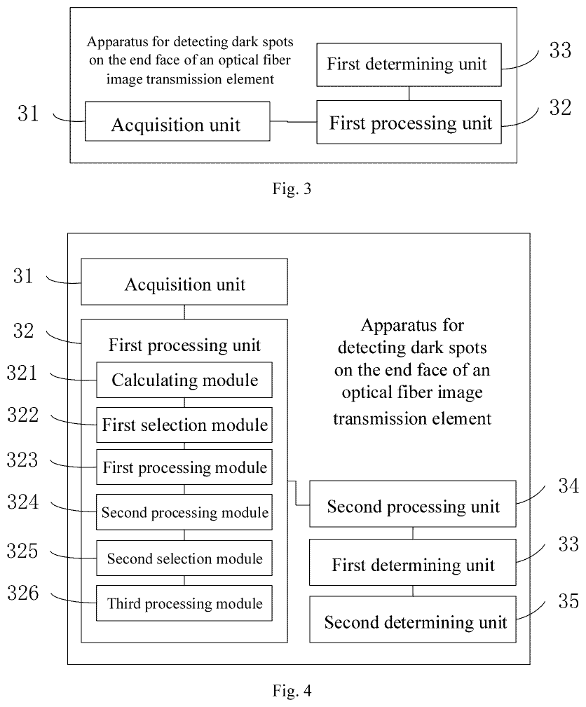

Further, as an implementation of the methods shown in FIGS. 1 and 2 above, another embodiment of the present application also provides an apparatus for detecting dark spots on the end face of an optical fiber image transmission element. This apparatus embodiment corresponds to the above method embodiment. For the convenience of reading, the detailed content in the above method embodiment will not be repeated one by one in this apparatus embodiment. However, it should be clear that the apparatus in this embodiment can correspondingly implement all the contents in the above method embodiment. This apparatus is applied to improve the detection accuracy of dark spot detection on the optical fiber image transmission element. Specifically, as shown in FIG. 3, the apparatus includes:
an acquisition unit 31, configured to obtain a plurality of end face images corresponding to an optical fiber image transmission element to be detected, wherein the plurality of end face images are images obtained by capturing different regions of the end face of an optical fiber image transmission element to be detected through a shooting apparatus;
a first processing unit 32, configured to perform secondary windowed Fourier transform processing on each of the end face images based on a plurality of preset windows to generate a secondary masked image corresponding to each of the end face images, wherein the secondary masked image includes a plurality of closed regions; and
a first determining unit 33, configured to determine the number of dark spots included in each of the end face images and an area value corresponding to each dark spot according to the number of closed regions included in each of the secondary masked images and the number of pixel points included in each closed region.

Further, as shown in FIG. 4, the plurality of preset windows include a plurality of first preset windows and a plurality of second preset windows, wherein the first preset windows are Gaussian windows, and the second preset windows are inclined windows. The first processing unit 32 includes:
a calculation module 321, configured to calculate the number of occupied pixel points corresponding to the diameter of an mono fiber according to the diameter of the mono fiber corresponding to the optical fiber image transmission element to be detected and the pitch of a pixel point corresponding to the end face image;
a first selection module 322, configured to generate a target noise reduction matrix according to the number of occupied pixel points corresponding to the diameter of the mono fiber, and select a target Gaussian window from the plurality of first preset windows according to the number of occupied pixel points corresponding to the diameter of the mono fiber;
a first processing module 323, configured to perform convolution operation processing on each of the end face images using the target noise reduction matrix to obtain a noise reduction image corresponding to each of the end face images;
a second processing module 324, configured to perform windowed Fourier transform processing on each of the noise reduction images based on the target Gaussian window to generate a primary masked image corresponding to each of the end face images;
a second selection module 325, configured to select a target inclined window corresponding to each of the primary masked images from a plurality of second preset windows according to the number of occupied pixel points corresponding to the diameter of the mono fiber and a plurality of primary masked images; and
a third processing module 326, configured to perform windowed Fourier transform processing on each of the primary masked images based on the target inclined window corresponding to each of the primary masked images, so as to generate a secondary masked image corresponding to each of the end face images.

Further, as shown in FIG. 4, the second processing module 324 is specifically configured to perform windowed Fourier transform processing on the noise reduction image based on the target Gaussian window to obtain a fringe frequency field corresponding to the noise reduction image. The fringe frequency field includes the fringe frequency value corresponding to each pixel point in the noise reduction image; the fringe frequency value with the highest occurrence frequency in the fringe frequency field is determined as the reference fringe frequency value; the fringe frequency values greater than or equal to the reference fringe frequency value in the fringe frequency field are determined as the target fringe frequency values; the pixel point corresponding to each of the target fringe frequency values is determined as the target pixel point; and the gray value corresponding to each of the target pixel points is set to 0 in the noise reduction image to generate the primary masked image corresponding to the end face image.

Further, as shown in FIG. 4, the second processing module 324 is specifically configured to perform windowed Fourier transform processing on the noise reduction image based on the target Gaussian window to determine a horizontal fringe frequency value and a vertical fringe frequency value corresponding to each pixel point in the noise reduction image, calculate the fringe frequency value corresponding to each pixel point according to the horizontal fringe frequency value and the vertical fringe frequency value corresponding to each pixel point, and generate the fringe frequency field corresponding to the noise reduction image according to the fringe frequency values corresponding to a plurality of pixel points.

The second selection module 325 is specifically configured to select an unmasked pixel point of an mono fiber in the primary masked image, wherein the unmasked pixel point of the mono fiber is any pixel point within the unmasked region corresponding to any normally-emitting mono fiber; obtain the horizontal fringe frequency value and the vertical fringe frequency value corresponding to the unmasked pixel point of the mono fiber, and calculate the direction angle corresponding to the primary masked image according to the horizontal fringe frequency value and the vertical fringe frequency value corresponding to the unmasked pixel point of the mono fiber; and select the target inclined window corresponding to the primary masked image from the plurality of second preset windows according to the number of occupied pixel points corresponding to the diameter of the mono fiber and the direction angle corresponding to the primary masked image.

Further, as shown in FIG. 4, the third processing module 326 is specifically configured to perform windowed Fourier transform processing on the primary masked image based on the target inclined window corresponding to the primary masked image, so as to obtain the fringe frequency field corresponding to the primary masked image, wherein the fringe frequency field includes the fringe frequency value corresponding to each pixel point in the primary masked image; determine the fringe frequency value with the highest occurrence frequency in the fringe frequency field as the reference fringe frequency value; determine the fringe frequency value which is greater than or equal to the reference fringe frequency value in the fringe frequency field as a target fringe frequency value; determine the pixel point corresponding to each of the target fringe frequency values as the target pixel point; and set the gray value corresponding to each of the target pixel points in the primary masked image to 0, so as to generate the secondary masked image corresponding to the end face image.

Further, as shown in FIG. 4, the apparatus further includes:
a second processing unit 34, configured to, after the first processing unit 32 performs secondary windowed Fourier transform processing on each of the end face images based on a plurality of preset windows to generate a secondary masked image corresponding to each of the end face images, perform binarization processing on each of the secondary masked images to obtain a binary image corresponding to each of the end face images; perform convolution operation processing on each of the binary images using a preset two-dimensional gradient operator to obtain a gradient matrix corresponding to each of the binary images; and perform edge processing on each of the binary images according to the gradient matrix corresponding to each of the binary images to obtain an edge image corresponding to each of the end face images.

The first determining unit 33, specifically configured to determine the number of dark spots included in each of the end face images and the area value corresponding to each dark spot according to the number of closed regions included in each of the edge images and the number of pixel points included in each closed region.

Further, as shown in FIG. 4, the apparatus further includes:
a second determining unit 35, configured to determine the total area value corresponding to a plurality of first dark spots included in each of the end face images, and determine the number of second dark spots, the number of third dark spots, and the number of fourth dark spots included in each of the end face images. The first dark spots are the dark spots in the end face image with an area value being less than or equal to the first preset area threshold; the second dark spots are the dark spots in the end face image with an area value being greater than the first preset area threshold and less than or equal to the second preset area threshold; the third dark spots are the dark spots in the end face image with an area value being greater than the second preset area threshold and less than or equal to the third preset area threshold; and the fourth dark spots are the dark spots in the end face image with an area value being greater than the third preset area threshold. When the total area value corresponding to a plurality of first dark spots included in any end face image is greater than the fourth preset area threshold, the optical fiber image transmission element to be detected is determined as an unqualified element in dark spot detection. When the number of second dark spots included in any end face image is greater than the first quantity threshold, the optical fiber image transmission element to be detected is determined as an unqualified element in dark spot detection. When the number of third dark spots included in any end face image is greater than the second quantity threshold, the optical fiber image transmission element to be detected is determined as an unqualified element in dark spot detection. When the number of fourth dark spots included in any end face image is greater than the third quantity threshold, the optical fiber image transmission element to be detected is determined as an unqualified element in dark spot detection.

The embodiments of the present application provide a method and apparatus for detecting dark spots on the end face of an optical fiber image transmission element. In the embodiments of the present application, after inspectors capture a plurality of end face images corresponding to the optical fiber image transmission element to be detected by using a shooting apparatus and store the plurality of end face images corresponding to the optical fiber image transmission element to be detected in a local storage space of a target terminal device, a dark spot detection application obtains a plurality of end face images corresponding to the optical fiber image transmission element to be detected from the local storage space of the target terminal device, then performs secondary windowed Fourier transform processing on each end face image based on a plurality of preset windows, to generate a secondary masked image corresponding to each end face image. For any end face image, its corresponding secondary masked image includes a plurality of closed regions. For any closed region, it corresponds to a dark spot or a dust particle. Moreover, the dark spot detection application determines the number of dark spots included in each of the end face images and the area value corresponding to each dark spot according to the number of closed regions included in each secondary masked image and the number of pixel points included in each closed region. In the embodiments of the present application, the inspectors only need to capture a plurality of end face images corresponding to the optical fiber image transmission element to be detected by using the shooting apparatus, then the dark spot detection application can determine the number of dark spots included in each of the end face images and the area value corresponding to each dark spot, and also determine the number of dark spots included in the end face of the optical fiber image transmission element to be detected and the area size of each dark spot. No intervention from the inspectors is required throughout the whole process, thereby eliminating dependence on the work experience and working state of the inspectors, and improving the detection accuracy of dark spot detection for optical fiber image transmission elements.

The embodiments of the present application provide a storage medium, wherein the storage medium includes a stored program, when the program runs, it controls a device where the storage medium is located to execute the above method for detecting dark spots on the end face of an optical fiber image transmission element.

The storage medium may include a non-permanent memory in a computer-readable medium, in forms such as a random access memory (RAM) and/or a non-volatile memory, e.g., a read-only memory (ROM) or a flash RAM, and the memory includes at least one storage chip.

The embodiments of the present application also provide an apparatus for detecting dark spots on the end face of an optical fiber image transmission element. The apparatus includes a storage medium and one or more processors, wherein the storage medium is coupled to the processor, and the processor is configured to execute program instructions stored in the storage medium; and the program instructions, when running, execute the above method for detecting dark spots on the end face of an optical fiber image transmission element.

The embodiments of the present application provide a device. The device includes a processor, a memory, and a program stored in the memory and executable on the processor. When the processor executes the program, the following steps are implemented:
obtaining a plurality of end face images corresponding to an optical fiber image transmission element to be detected, wherein the plurality of end face images are obtained by capturing different regions of the end face of the optical fiber image transmission element to be detected by using a shooting apparatus;
performing secondary windowed Fourier transform processing on each of the end face images based on a plurality of preset windows to generate a secondary masked image corresponding to each of the end face images, wherein the secondary masked image includes a plurality of closed regions; and
determining the number of dark spots included in each of the end face images and an area value corresponding to each dark spot according to the number of closed regions included in each of the secondary masked images and the number of pixel points included in each closed region.

Further, the plurality of preset windows include a plurality of first preset windows and a plurality of second preset windows, wherein the first preset windows are Gaussian windows and the second preset windows are inclined windows; the step of performing secondary windowed Fourier transform processing on each of the end face images based on a plurality of preset windows to generate a secondary masked image corresponding to each of the end face images includes:
calculating the number of occupied pixel points corresponding to the diameter of the mono fiber according to the diameter of the mono fiber corresponding to the optical fiber image transmission element to be detected and the pitch of a pixel point corresponding to the end face image;
generating a target noise reduction matrix according to the number of occupied pixel points corresponding to the diameter of the mono fiber, and selecting a target Gaussian window from the plurality of first preset windows according to the number of occupied pixel points corresponding to the diameter of the mono fiber;
performing convolution operation processing on each of the end face images by using the target noise reduction matrix to obtain a noise reduction image corresponding to each of the end face images;
performing windowed Fourier transform processing on each of the noise reduction images based on the target Gaussian window to generate a primary masked image corresponding to each of the end face images;
selecting a target inclined window corresponding to each of the primary masked images from the plurality of second preset windows according to the number of occupied pixel points corresponding to the diameter of the mono fiber and the plurality of primary masked images; and
performing windowed Fourier transform processing on each of the primary masked images based on the target inclined window corresponding to each of the primary masked images to generate a secondary masked image corresponding to each of the end face images.

Further, the step of performing windowed Fourier transform processing on each of the noise reduction images based on the target Gaussian window to generate a primary masked image corresponding to each of the end face images includes:
performing windowed Fourier transform processing on the noise reduction image based on the target Gaussian window to obtain a fringe frequency field corresponding to the noise reduction image, wherein the fringe frequency field includes the fringe frequency value corresponding to each of the pixel points in the noise reduction image;
determining a fringe frequency value with the highest occurrence frequency in the fringe frequency field as the reference fringe frequency value;
determining the fringe frequency values in the fringe frequency field that are greater than or equal to the reference fringe frequency value as target fringe frequency values;
determining the pixel point corresponding to each target fringe frequency value as a target pixel point; and
setting a gray value corresponding to each of the target pixel points in the noise reduction image to 0 to generate a primary masked image corresponding to the end face image.

Further, the step of performing windowed Fourier transform processing on the noise reduction image based on the target Gaussian window to obtain a fringe frequency field corresponding to the noise reduction image includes:
performing windowed Fourier transform processing on the noise reduction image based on the target Gaussian window to determine a horizontal fringe frequency value and a vertical fringe frequency value corresponding to each of the pixel points in the noise reduction image;
calculating the fringe frequency value corresponding to each of the pixel points according to the horizontal fringe frequency value and the vertical fringe frequency value corresponding to each of the pixel points; and
generating a fringe frequency field corresponding to the noise reduction image according to fringe frequency values corresponding to the plurality of pixel points.

The step of selecting a target inclined window corresponding to each of the primary masked images from the plurality of second preset windows according to the number of occupied pixel points corresponding to the diameter of the mono fiber and the plurality of primary masked images includes:
selecting an unmasked pixel point of the mono fiber in the primary masked image, wherein the unmasked pixel point of the mono fiber refers to any pixel point within the unmasked region corresponding to any normally-emitting mono fiber;
obtaining a horizontal fringe frequency value and a vertical fringe frequency value corresponding to the unmasked pixel point of the mono fiber, and calculating a direction angle corresponding to the primary masked image according to the horizontal fringe frequency value and the vertical fringe frequency value corresponding to the unmasked pixel point of the mono fiber; and
selecting a target inclined window corresponding to the primary masked image from the plurality of second preset windows according to the number of occupied pixel points corresponding to the diameter of the mono fiber and a direction angle corresponding to the primary masked image.

Further, the step of performing windowed Fourier transform processing on each of the primary masked images based on a target inclined window corresponding to each of the primary masked images to generate a secondary masked image corresponding to each of the end face images includes:
performing windowed Fourier transform processing on the primary masked image based on a target inclined window corresponding to the primary masked image to obtain a fringe frequency field corresponding to the primary masked image, wherein the fringe frequency field includes the fringe frequency value corresponding to each of the pixel points in the primary masked image;
determining a fringe frequency value with the highest occurrence frequency in the fringe frequency field as a reference fringe frequency value;
determining a fringe frequency value which is greater than or equal to the reference fringe frequency value in the fringe frequency field as a target fringe frequency value;
determining a pixel point corresponding to each of the target fringe frequency values as a target pixel point;
setting a gray value of each of the target pixel points in the primary masked image to 0 to generate a secondary masked image corresponding to the end face image.

Further, after the step of performing secondary windowed Fourier transform processing on each of the end face images based on a plurality of preset windows to generate a secondary masked image corresponding to each of the end face images, the method further includes:
performing binarization processing on each of the secondary masked images to obtain a binary image corresponding to each of the end face images;
performing convolution operation processing on each of the binary images using a preset two-dimensional gradient operator to obtain a gradient matrix corresponding to each of the binary images; and
performing edge processing on each of the binary images according to a gradient matrix corresponding to each of the binary images to obtain an edge image corresponding to each of the end face images.

The step of determining the number of dark spots included in each of the end face images and an area value corresponding to each dark spot according to the number of closed regions included in each of the secondary masked images and the number of pixel points included in each closed region includes:
determining the number of dark spots included in each of the end face images and an area value corresponding to each dark spot according to the number of closed regions included in each of the edge images and the number of pixel points included in each closed region.

Further, the method further includes:
determining the total area value corresponding to a plurality of first dark spots included in each of the end face images, and determining the number of second dark spots, the number of third dark spots, and the number of fourth dark spots included in each of the end face images, wherein the first dark spots are the dark spots in the end face image with an area value being less than or equal to the first preset area threshold; the second dark spots are the dark spots in the end face image with an area value being greater than the first preset area threshold and less than or equal to the second preset area threshold; the third dark spots are the dark spots in the end face image with an area value being greater than the second preset area threshold and less than or equal to the third preset area threshold; and the fourth dark spots are the dark spots in the end face image with an area value being greater than the third preset area threshold;
when the total area value corresponding to the plurality of first dark spots included in any end face image is greater than a fourth preset area threshold, determining that the optical fiber image transmission element to be detected is an unqualified element in dark spot detection;
when the number of the second dark spots included in any one of the end face images is greater than a first quantity threshold, determining that the optical fiber image transmission element to be detected is an unqualified element in dark spot detection;
when the number of the third dark spots included in any one of the end face images is greater than a second quantity threshold, determining that the optical fiber image transmission element to be detected is an unqualified element in dark spot detection; and
when the number of the fourth dark spots included in any one of the end face images is greater than a third quantity threshold, determining that the optical fiber image transmission element to be detected is an unqualified element in dark spot detection.

The present application also provides a computer program product. When executed on a data processing device, the computer program product is suitable for executing program code initialized with the following method steps: obtaining a plurality of end face images corresponding to an optical fiber image transmission element to be detected, wherein the plurality of end face images are obtained by capturing different regions of the end face of the optical fiber image transmission element to be detected by using a shooting apparatus; performing secondary windowed Fourier transform processing on each of the end face images based on a plurality of preset windows to generate a secondary masked image corresponding to each of the end face images, wherein the secondary masked image includes a plurality of closed regions; and determining the number of dark spots included in each of the end face images and an area value corresponding to each dark spot according to the number of closed regions included in each of the secondary masked images and the number of pixel points included in each closed region.

Those skilled in the art should understand that the embodiments of the present application can be provided as a method, a system, or a computer program product. Therefore, the present application can take the form of an entirely hardware embodiment, an entirely software embodiment, or an embodiment combining software and hardware aspects. Moreover, the present application can take the form of a computer program product implemented on one or more computer-usable storage media (including but not limited to disk storage, CD-ROM, optical storage, etc.) having computer-usable program code embodied therein.

The present application is described with reference to flowcharts and/or block diagrams of methods, devices (systems), and computer program products according to embodiments of the present application. It should be understood that each process and/or block in the flowcharts and/or block diagrams, and combinations of processes and/or blocks in the flowcharts and/or block diagrams can be implemented by computer program instructions. These computer program instructions can be provided to the processor of a general-purpose computer, a special-purpose computer, an embedded processor, or other programmable data processing devices to produce a machine, such that the instructions executed by the processor of the computer or other programmable data processing devices produce means for implementing the functions specified in one or more processes of the flowchart and/or one or more blocks of the block diagram.

These computer program instructions may also be stored in a computer-readable memory capable of directing a computer or other programmable data processing devices to operate in a particular manner, such that the instructions stored in the computer-readable memory produce an article of manufacture including instruction means, and the instruction means implement the functions specified in one or more processes of the flowchart and/or in one or more blocks of the block diagram.

These computer program instructions can also be loaded onto a computer or other programmable data processing device, such that a series of operational steps are executed on the computer or other programmable devices to generate computer-implemented processing. Therefore, the instructions executed on the computer or other programmable devices provide steps for implementing the functions specified in one or more processes of the flowchart and/or one or more blocks of the block diagram.

In a typical configuration, a computing device includes one or more processors (CPUs), input/output interfaces, network interfaces, and memories.

The memory may include a non-permanent memory in the computer-readable medium, in forms such as a random access memory (RAM) and/or a non-volatile memory, e.g., a read-only memory (ROM) or a flash random access memory (flash RAM). The memory is an example of a computer-readable medium.

Computer-readable media, including both permanent and non-permanent, removable and non-removable media, can store information by any method or technology. The information can be computer-readable instructions, data structures, program modules, or other data. Examples of computer storage media include, but are not limited to, a phase-change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage means, magnetic cassette tapes, magnetic tapes, magnetic disk storage or other magnetic storage devices, or any other non-transmission medium that can be used to store information accessible by computing devices. As defined in this text, computer-readable media do not include transitory media, such as modulated data signals and carrier waves.

It should also be noted that the terms “comprise”, “include” or any other variants thereof are intended to cover non-exclusive inclusion. Therefore, a process, method, commodity or device that includes a series of elements includes not only those elements, but also other elements not explicitly listed, or elements inherent in such process, method, commodity or device. Without further restrictions, an element defined by the statement “comprising a...” does not exclude the existence of other identical elements in the process, method, commodity or device that includes the element.

Those skilled in the art should understand that the embodiments of the present application can be provided as a method, a system, or a computer program product. Therefore, the present application can take the form of an entirely hardware embodiment, an entirely software embodiment, or an embodiment combining software and hardware aspects. Moreover, the present application can take the form of a computer program product implemented on one or more computer-usable storage media (including but not limited to disk storage, CD-ROM, optical storage, etc.) having computer-usable program code embodied therein.

The above are merely examples of the present application and are not intended to limit the present application. For those skilled in the art, various modifications and changes can be made to the present application. Any modification, equivalent substitution, improvement and the like made within the spirit and principle of the present application shall fall within the scope of the claims of the present application.

1. A method for detecting dark spots on an end face of an optical fiber image transmission element, characterized in that the method comprises:
obtaining a plurality of end face images corresponding to an optical fiber image transmission element to be detected, wherein the plurality of end face images are obtained by capturing different regions of the end face of the optical fiber image transmission element to be detected using a shooting apparatus;
performing secondary windowed Fourier transform processing on each of the end face images based on a plurality of preset windows to generate a secondary masked image corresponding to each of the end face images, wherein the secondary masked image includes a plurality of closed regions; and
determining the number of dark spots included in each of the end face images and an area value corresponding to each dark spot according to the number of closed regions included in each of the secondary masked images and the number of pixel points included in each of closed regions.

2. The method according to claim 1, wherein the plurality of preset windows include a plurality of first preset windows and a plurality of second preset windows, wherein the first preset windows are Gaussian windows and the second preset windows are inclined windows; the step of performing secondary windowed Fourier transform processing on each of the end face images based on a plurality of preset windows to generate a secondary masked image corresponding to each of the end face images comprises:
calculating the number of occupied pixel points corresponding to a diameter of an mono fiber according to a diameter of an mono fiber corresponding to the optical fiber image transmission element to be detected and a pitch of a pixel point corresponding to the end face image;
generating a target noise reduction matrix according to the number of occupied pixel points corresponding to a diameter of an mono fiber, and selecting a target Gaussian window from the plurality of first preset windows according to the number of occupied pixel points corresponding to a diameter of an mono fiber;
performing convolution operation processing on each of the end face images by using the target noise reduction matrix to obtain a noise reduction image corresponding to each of the end face images;
performing windowed Fourier transform processing on each of the noise reduction images based on the target Gaussian window to generate a primary masked image corresponding to each of the end face images;
selecting a target inclined window corresponding to each of the primary masked images from the plurality of second preset windows according to the number of occupied pixel points corresponding to the diameter of an mono fiber and the plurality of primary masked images; and
performing windowed Fourier transform processing on each of the primary masked images based on the target inclined window corresponding to each of the primary masked images to generate a secondary masked image corresponding to each of the end face images.

3. The method according to claim 2, wherein the step of performing window Fourier transform processing on each of the noise reduction images based on the target Gaussian window to generate a primary masked image corresponding to each of the end face images comprises:
performing windowed Fourier transform processing on the noise reduction image based on the target Gaussian window to obtain a fringe frequency field corresponding to the noise reduction image, wherein the fringe frequency field includes a fringe frequency value corresponding to each of pixel points in the noise reduction image;
determining a fringe frequency value with the highest occurrence frequency in the fringe frequency field as a reference fringe frequency value;
determining the fringe frequency values in the fringe frequency field that are greater than or equal to the reference fringe frequency value as target fringe frequency values;
determining the pixel point corresponding to each of the target fringe frequency values as a target pixel point; and
setting the gray value of each of the target pixel points in the noise reduction image to 0 to generate the primary masked image corresponding to the end face image.

4. The method according to claim 3, wherein the step of performing window Fourier transform processing on the noise reduction image based on the target Gaussian window to obtain a fringe frequency field corresponding to the noise reduction image comprises:
performing windowed Fourier transform processing on the noise reduction image based on the target Gaussian window to determine a horizontal fringe frequency value and a vertical fringe frequency value corresponding to each of pixel points in the noise reduction image;
calculating the fringe frequency value corresponding to each of the pixel points according to the horizontal fringe frequency value and vertical fringe frequency value corresponding to each of the pixel points; and
generating a fringe frequency field corresponding to the noise reduction image according to fringe frequency values corresponding to the plurality of pixel points;
the step of selecting a target inclined window corresponding to each of the primary masked images from the plurality of second preset windows according to the number of occupied pixel points corresponding to the diameter of an mono fiber and the plurality of primary masked images comprises:
selecting an unmasked pixel point of an mono fiber in the primary masked image, wherein the unmasked pixel point refers to any pixel point within the unmasked region corresponding to any normally luminescent mono fiber;
obtaining a horizontal fringe frequency value and a vertical fringe frequency value corresponding to the unmasked pixel point of the mono fiber, and calculating a direction angle corresponding to the primary masked image according to a horizontal fringe frequency value and a vertical fringe frequency value corresponding to the unshielded pixel point of an mono fiber; and
selecting a target inclined window corresponding to the primary masked image from the plurality of second preset windows according to the number of occupied pixel points corresponding to the diameter of an mono fiber and a direction angle corresponding to the primary masked image.

5. The method according to claim 2, wherein the step of performing window Fourier transform processing on each of the primary masked images based on a target inclined window corresponding to each of the primary masked images to generate a secondary masked image corresponding to each of the end face images comprises:
performing windowed Fourier transform processing on the primary masked image based on a target inclined window corresponding to the primary masked image to obtain a fringe frequency field corresponding to the primary masked image, wherein the fringe frequency field includes the fringe frequency value corresponding to each of the pixel points in the primary masked image;
determining a fringe frequency value with the highest occurrence frequency in the fringe frequency field as a reference fringe frequency value;
determining a fringe frequency value which is greater than or equal to the reference fringe frequency value in the fringe frequency field as a target fringe frequency values;
determining a pixel point corresponding to each of the target fringe frequency values as a target pixel point; and
setting a gray value of each of the target pixel points in the primary masked image to 0 to generate a secondary masked image corresponding to the end face image.

6. The method according to claim 1, wherein after the step of performing secondary window Fourier transform processing on each of the end face images based on a plurality of preset windows to generate a secondary masked image corresponding to each of the end face images, the method further comprises:
performing binarization processing on each of the secondary masked images to obtain a binary image corresponding to each of the end face images;
performing convolution operation processing on each of the binary images using a preset two-dimensional gradient operator to obtain a gradient matrix corresponding to each of the binary images; and
performing edge processing on each of the binary images according to a gradient matrix corresponding to each of the binary images to obtain an edge image corresponding to each of the end face images;
the step of determining the number of dark spots included in each of the end face images and an area value corresponding to each dark spot according to the number of closed regions included in each of the secondary masked images and the number of pixel points included in each of closed regions comprises:
determining the number of dark spots included in each of the end face images and an area value corresponding to each dark spot according to the number of closed regions included in each of the edge images and the number of pixel points included in each closed region.

7. The method according to claim 1, wherein the method further comprises:
determining a total area value corresponding to a plurality of first dark spots included in each of the end face images, and determining the number of second dark spots, the number of third dark spots and the number of fourth dark spots included in each of the end face images, wherein the first dark spot is a dark spot with an area value less than or equal to a first preset area threshold in the end face image, the second dark spot is a dark spot with an area value greater than the first preset area threshold and less than or equal to a second preset area threshold in the end face image, the third dark spot is a dark spot with an area value greater than the second preset area threshold and less than or equal to a third preset area threshold in the end face image, and the fourth dark spot is a dark spot with an area value greater than the third preset area threshold in the end face image;
when the total area value corresponding to the plurality of first dark spots included in any end face image is greater than a fourth preset area threshold, determining that the optical fiber image transmission element to be detected is an unqualified element in dark spot detection;
when the number of the second dark spots included in any one of the end face images is greater than a first quantity threshold, determining that the optical fiber image transmission element to be detected is an unqualified element in dark spot detection;
when the number of the third dark spots included in any one of the end face images is greater than a second quantity threshold, determining that the optical fiber image transmission element to be detected is an unqualified element in dark spot detection; and
when the number of the fourth dark spots included in any one of the end face images is greater than a third quantity threshold, determining that the optical fiber image transmission element to be detected is an unqualified element in dark spot detection.

8. An apparatus for detecting dark spots on an end face of an optical fiber image transmission element, the apparatus comprising:
an acquisition unit, configured to obtain a plurality of end face images corresponding to an optical fiber image transmission element to be detected, wherein the plurality of end face images are images obtained by capturing different regions of the end face of an optical fiber image transmission element to be detected through a photographing apparatus;
a first processing unit, configured to perform secondary window Fourier transform processing on each of the end face images based on a plurality of preset windows to generate a secondary masked image corresponding to each of the end face images, wherein the secondary masked image includes a plurality of closed regions; and
a first determining unit, configured to determine the number of dark spots included in each of the end face images and an area value corresponding to each of dark spots according to the number of closed regions included in each of the secondary masked images and the number of pixel points included in each of closed regions.

9. A storage medium, characterized in that the storage medium includes a stored program, wherein when the program runs, it controls a device where the storage medium is located to execute the method for detecting dark spots on an end face of an optical fiber image transmission element according to claim 1.

10. An apparatus for detecting dark spots on an end face of an optical fiber image transmission element, the apparatus comprising a storage medium; and one or more processors, the storage medium is coupled to the processor, and the processor is configured to execute program instructions stored in the storage medium; the program instructions, when running, execute the method for detecting dark spots on an end face of an optical fiber image transmission element according to claim 1.
